(19) United States
(12) Patent Application Publication
(10) Pub. No.: US 2005/0044407 A1
(43) Pub. Date: Feb. 24, 2005

(54) Low-to-high information security protection mechanism

(75) Inventors: Douglas Marquis, Weston, MA (US); James O. Calvin, Lexington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Massachusetts Institute of Technology, Cambridge, MA (US)

(21) Appl. No.: 10/643,428

(22) Filed: Aug. 19, 2003

(51) Int. Cl. H04L 9/00

(52) U.S. Cl. 713/201

(57) ABSTRACT

A system and method for communicating data from a low security assurance source to a high security assurance destination in which information data is transferred from the low end source to the high end destination, but acknowledgments from the high end destination are not directly returned back to the originating source. Rather, receipt of an acknowledgment from a high end destination triggers the generation of a new acknowledgment which is then transmitted back to the originating low end source to acknowledge receipt of the information data. The low end acknowledgment may be generated from an acknowledgment template in which the data payload is empty.

### GOVERNMENT SUPPORT

The invention was supported, in whole or in part, by a grant F19628-00-C-0002 from the United States Air Force. The Government has certain rights in the invention.

### BACKGROUND OF THE INVENTION

Communication networks typically employ a variety of security measures to prevent access to and communications with its computing and storage devices. For example, financial institution and government networks typically implement different levels of security depending on the privacy requirements, or classification of the information being protected. This generally results in a security-based hierarchy in which devices on lower security networks are not permitted to communicate with devices on higher security networks.

However, there are instances in which information needs to be communicated from a lower security network to a higher security network. In such instances, a low end source is allowed to transfer information to the high end destination, but no information must be allowed to transfer in the reverse direction. This is sometimes referred to as the low-to-high problem.

### SUMMARY OF THE INVENTION

In recent years, the principal means of providing such security involved severing the physical connections that are capable of sending data from the higher security network to the lower security network. Such measures prevent the reverse flow of information from higher-to-lower security networks. However, such measures also prevent the flow of acknowledgments required in acknowledgment based communication protocols to provide reliable end-to-end communication of information data transfers.

Acknowledgment based communication protocols, for example TCP/IP, transmit acknowledgments in order to establish network communications and to allow receivers of information data to acknowledge receipt of that information to an originating sender. Acknowledgment based communication protocols also include handshaking protocols that involve multiple levels of acknowledgments. For example, in addition to acknowledging data receipt, the receiver may send acknowledgments to an originating sender indicating whether the information was received on-time and error-free. Other acknowledgment based communication protocols are known to those skilled in the art.

The present invention facilitates the use of acknowledgment based communication protocols for reliable end-to-end communication of information data transfers from a low security assurance source to a high security assurance destination, while preventing information transfers in the reverse direction from high to low. The high end security assurance destination may be a network device or system. Alternatively, the high end security assurance destination may be an software application process.

In particular, the present invention involves a system and method for communicating data from a low security assurance source (“low end source”) to a high security assurance destination (“high end destination”) in which information data is transferred from the low end source to the high end destination. To prevent information transfers in the reverse direction, acknowledgments from the high end destination are not directly returned back to the originating source. Rather, receipt of an acknowledgment from a high end destination (i.e., high end acknowledgment) triggers the generation of a new acknowledgment (i.e., low end acknowledgment) which is then transmitted back to the originating low end source to acknowledge receipt of the information data.

Embodiments of the present invention may include (i) a first communication interface that receives data from a low security assurance source according to a communication protocol and transfers the data to a high security assurance destination according to the communication protocol; (ii) a second communication interface that receives a high end acknowledgment according to the communication protocol from the high security assurance destination; (iii) an acknowledgment trigger that generates an acknowledgment trigger signal in response to the high end acknowledgment; and (iv) an acknowledgment generator that generates a low end acknowledgment according to the communication protocol in response to the acknowledgment trigger signal.

The acknowledgment trigger may also determine whether to generate an acknowledgment trigger signal by determining whether the high end acknowledgment includes information data and may generate no acknowledgment trigger signal if information data is included in the high end acknowledgment. Alternatively, the acknowledgment trigger may strip non-acknowledgment information and include the resulting header data in the trigger signal for generating the low end acknowledgment.

To prevent transmissions of low end acknowledgments to unknown sources, the acknowledgment trigger may also include an authorization list identifying low security assurance sources that are authorized to receive low end acknowledgments. The authorization list may be referenced to determine whether an intended recipient of the high end acknowledgment is authorized to receive acknowledgments. If the low security assurance source is not identified in the authorization list, the acknowledgment trigger may not generate an acknowledgment trigger signal to initiate generation of the low end acknowledgment.

To prevent covert transmission of information encoded in timed transmissions of acknowledgments, the acknowledgment trigger may include a delay that delays the acknowledgment trigger signal for a random time period in order to delay generation of the low end acknowledgment. Such delays disrupt the timing mechanism of the covert data transfer protocol.

In particular embodiments, the acknowledgment trigger signal may include header data for generating the low end acknowledgment. When the trigger signal includes header data, the acknowledgment generator may generate the low end acknowledgment from, for example, an acknowledgment template and populate the low end acknowledgment with the header data from the acknowledgment trigger signal.

In alternative embodiments, the acknowledgment trigger signal is a binary enable signal. When the trigger signal is a binary enable signal, the acknowledgment trigger may include a sequence list that tracks a sequence of plural data transmission units (e.g., packets or frames) transferred to the high security assurance destination. The sequence list may be referenced to determine whether the received high end acknowledgment corresponds to a next unacknowledged data transmission unit in the tracked sequence. If so, the acknowledgment trigger generates the binary trigger signal.

Similarly, when the trigger signal is a binary enable signal, the acknowledgment generator may include a header data list that tracks header data for each data transmission unit in a sequence of plural data transmission units transferred to the high security assurance destination. In response to the binary trigger signal, the acknowledgment generator generates the low end acknowledgment from, for example, an acknowledgment template and populates the low end acknowledgment with the header data from the header data list for a next unacknowledged data transmission unit in the sequence.

Particular embodiments of the invention may be implemented as, for example, stand-alone network devices, output ports or embedded components of output ports, or embedded components in software. Such embodiment may be implemented in hardware, software or a combination of both.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a diagram illustrating a system in which data is transferred from a low security assurance network to a high security assurance network according to one embodiment;

FIG. 1B is a diagram illustrating output ports having embedded network isolators according to one embodiment;

FIG. 1C is a diagram illustrating a network isolator as an embedded software component according to one embodiment;

FIG. 2 is a flow chart illustrating a method of communicating data from a low security assurance network to a high security assurance network according to one embodiment;

FIG. 3 is a diagram illustrating a network isolator according to one embodiment;

FIG. 4 is a diagram illustrating an acknowledgment trigger and an acknowledgment generator according to the embodiment of FIG. 3;

FIG. 5 is a diagram illustrating the open and default parameters of an acknowledgment template for TCP/IP according to one embodiment;

FIG. 6 is a diagram illustrating a network isolator according to an alternative embodiment;

FIG. 7 is a diagram illustrating an acknowledgment trigger and an acknowledgment generator according to the embodiment of FIG. 6;

FIG. 8 is a diagram illustrating a network isolator in a time controlled network system according to one embodiment;

FIG. 9A is a diagram illustrating multiple header data lists according to one embodiment; and

FIG. 9B is a diagram illustrating multiple sequence lists according to one embodiment.

FIG. 10 is a diagram illustrating details of the network isolator according to the embodiment of FIG. 1C.

### DETAILED DESCRIPTION OF THE INVENTION

A description of preferred embodiments of the invention follows.

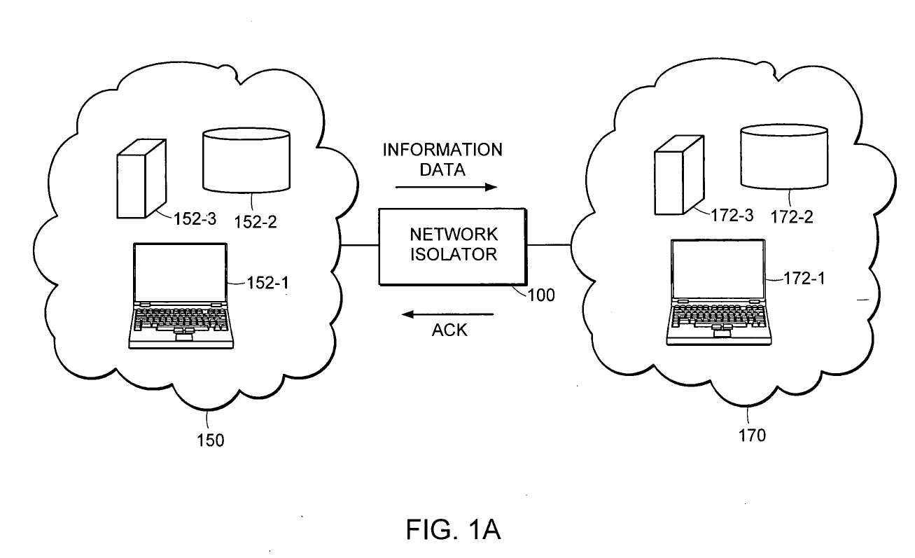

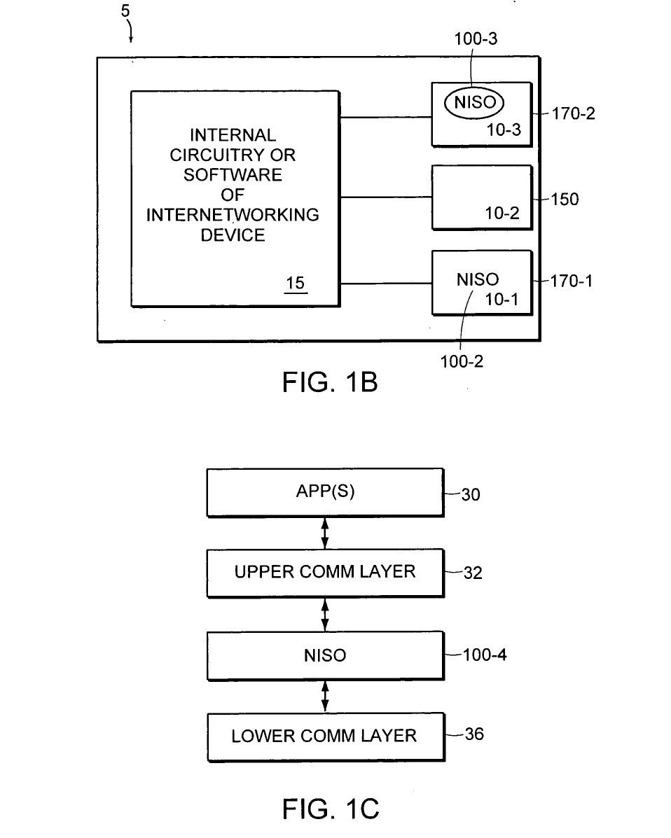

FIG. 1A is a diagram illustrating a system in which data is transferred from a low security assurance network to a high security assurance network according to one embodiment. In particular, the illustrated stand-alone network device facilitates end-to-end communication for acknowledged information data transfers from the low security assurance network 150 to the high security assurance network 170, but prevents information data transfers in the reverse direction from high to low.

The low security assurance network 150 may include one or more sources 152 having information data that may be transferred to one or more destinations 172 in the high security assurance network 170. The terms “low and high security assurance” are relative terms that refer to corresponding levels of protection implemented within a network to secure data. An example of a low security assurance network is the Internet, while government networks managing classified data or financial networks managing highly sensitive data are examples of high security assurance networks. However, it should be apparent that embodiments of the invention are applicable to any system in which unilateral data transfers using acknowledgment-based communication protocols are desired. TCP, XCP, SCSP, XTP, and FT4 are examples of acknowledgment-based communication protocols. SONET and ATM also implement acknowledgment-based communication protocols.

The illustrated system includes a network isolator 100 which serves as an interface between the low end network 150 and the high end network 170. To facilitate end-to-end communication for information data transfers from low to high, the network isolator 100 forwards information data from a low end source 152 to a high end destination 172. However, in response to a corresponding acknowledgment from destination 172 (“high end acknowledgment”), the network isolator 100 terminates further transmission of the high end acknowledgment and generates a new acknowledgment (“low end acknowledgment”) for transmission to the low end source 152. Such embodiments allow information data transfers from low to high using acknowledgment-based communication protocols, while preventing information data transfers from high to low.

FIGS. 1B and 1C provide additional examples of embodiments of the network isolator. In particular, FIG. 1B is a diagram illustrating output ports having embedded network isolators according to one embodiment. By selectively implementing an output port with a network isolator, an internetworking device (e.g., router, switch, or firewall) can provide secured access on a per port basis.

For example, the internetworking device 5 includes internal circuitry 15 for interconnecting output ports 10-1, 10-2, and 10-3. Output ports 10-1 and 10-3 couple to high security assurance networks 170-1, 170-2, respectively, while output port 10-2 couples to low security assurance network 150.

In the illustrated embodiment, network isolator 100-2 serves as an output port 10-1 providing secured access to high end network 170-1. Alternatively, network isolator 100-3 is a software component providing embedded functionality in output port 10-3 for secured access to high end network 170-2. A standard link layer interface processor may serve as output port 10-2 for coupling to low end network 150.

Both network isolators 100-2 and 100-3 provide secured access by allowing information data transfers from the low security network 150 to the corresponding high security networks 170-1, 170-2, but preventing information transfers in the reverse direction. In response to receiving an acknowledgments from the high end networks 170-1, 170-2, network isolators 100-2, 100-3 terminate further transmission of the high end acknowledgments and generate new acknowledgments for transmission to the low end network 150 via internal circuitry or software 15.

Similarly, a client or server computing device may also include output ports having embedded network isolators. In this embodiment, information data transfers are allowed into the client/server device, but no information transfers are allowed in the reverse direction.

FIG. 1C is a diagram illustrating a network isolator as an embedded software component according to one embodiment. In the illustrated embodiment, one or more application processes 30 are supported by an upper level communication layer 32 and a lower level communication layer 36. The network isolator 100-4 is integrated into this stack as an embedded software component that serves as an interface or “shim” between the upper level communication layer 32 and the lower level communication layer 36. In this embodiment, the high security assurance destination is a software application process 30. In particular, the network isolator 100-4 allows information data received by the lower level communication layer 36 to pass to the destination application process 30 via the upper level communication layer 32, but prevents any information transfers from the application and upper level communication layers 30, 32 to the lower level communication layer 36. For example, in response to receiving an acknowledgment from the software process 30 (i.e., high end destination), network isolator 100-4 terminates further transmission of the high end acknowledgment and generates a new acknowledgment for transmission to the appropriate low end source via the lower level communication layer 36. Thus, in this embodiment, the network isolator 100-4 provides secured access to application executing on a server or client device.

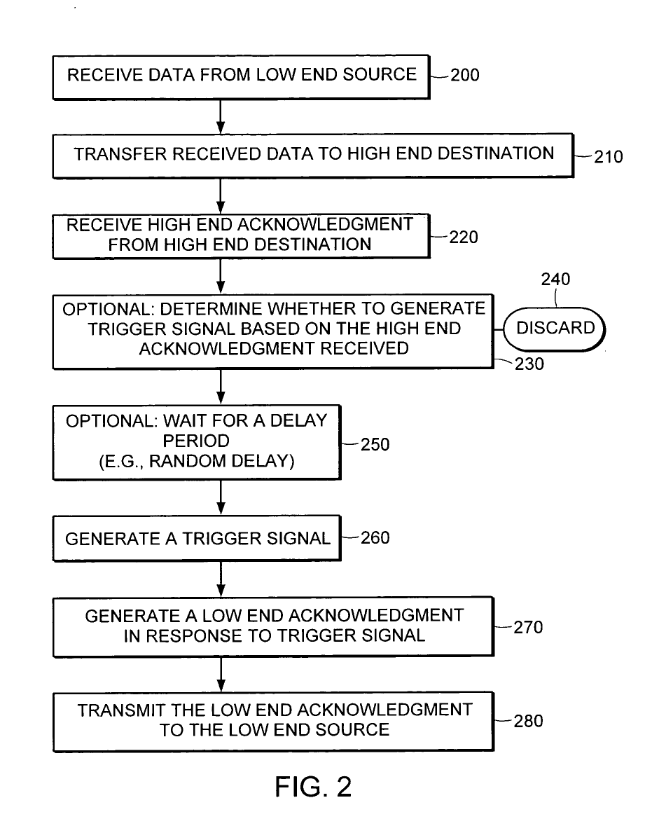

FIG. 2 is a flow chart illustrating a method of communicating data from a low security assurance source to a high security assurance destination according to one embodiment. Embodiments of the method may be implemented by, for example, the network isolator of FIG. 1A-1C.

At 200, information data is received according to a communication protocol from a low end source 152 that is destined for a high end destination 172. It should be understood that any data transmission unit, including packets and frames, may serve as a mechanism for transferring data.

At 210, the received data is transmitted to the high end destination according to the communication protocol.

At 220, a high end acknowledgment is received from the high end destination 172 acknowledging receipt of the information data back to the originating low end source 152. The acknowledgments may also report errors, time information or other information specific to a handshaking communication protocol.

At 230, an optional determination is made as to whether a low end acknowledgment should be generated. If not, the high end acknowledgment may be discarded at 240 and the process ends.

Otherwise, at 250, a wait occurs for an optional delay period. Preferably, the delay period is a random delay which is less than a packet timeout period for the communication protocol. This optional delay is intended to prevent information transfers from high to low in which the information is encoded in timed transmissions of acknowledgments.

At 260, a trigger signal is generated to initiate the generation of the low end acknowledgment. The trigger signal may include data for generating the low end acknowledgment or may be a binary enable signal. Alternatively, the trigger signal may be generated, for example, by invoking a function or signaling a semaphore.

At 270, a low end acknowledgment is generated in response to the trigger signal. The low end acknowledgment may generated from, for example, a template of an acknowledgment according to the communication protocol.

At 280, the low end acknowledgment is transmitted to the originating low end source 152 to acknowledge receipt of the information data.

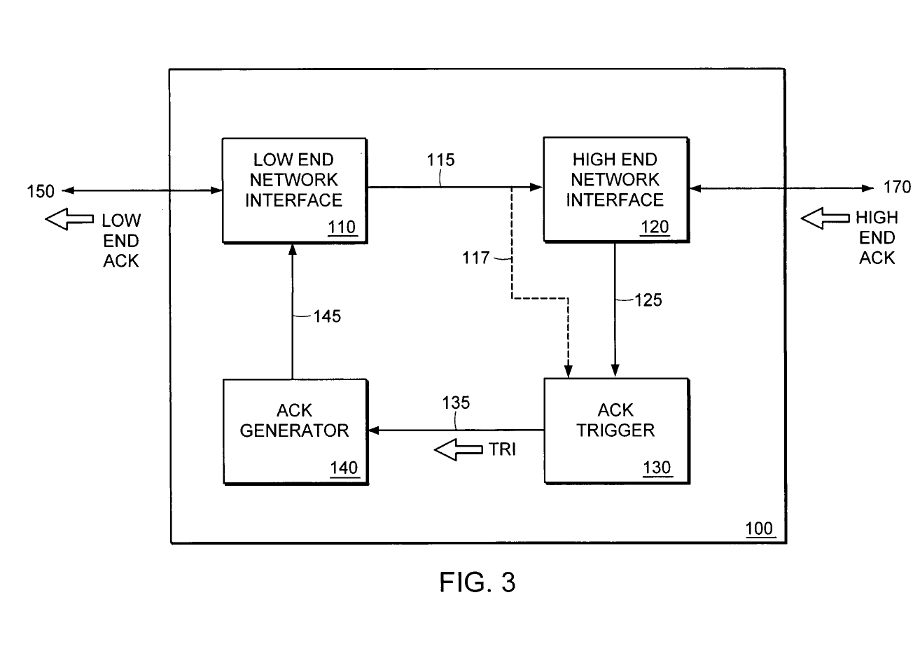

FIG. 3 is a diagram illustrating a network isolator according to one embodiment. The network isolator 100 may include network interfaces 110, 120 for externally interfacing with low and high end networks 150, 170, respectively. Alternatively, as in network isolator 100-2 of FIG. 1B, the low end network interface 110 or the high end network interface 120 may serve to couple the network isolator to the internal routing, switching, or firewall circuitry 15 of internetworking device 5. Network interfaces 110, 120 may be any link layer interface processor known to those skilled in the art.

Internally, the low and high end network interfaces 110, 120 are coupled to each other via link 115 to provide a one-way data path for transferring information data from the low end network 150 to the high end network 170. No information relating to the high side is transferred in the reverse direction from high to low over link 115.

In the reverse direction, the high end network interface 120 is isolated from the low end network interface 110 by an acknowledgment trigger 130 coupled to an acknowledgment generator 140. Network interface 120 forwards high end acknowledgments over link 125 to the acknowledgment trigger 130, where further transmission of high end acknowledgments are terminated. The acknowledgment trigger 130 may individually process each of the high end acknowledgments to determine whether to generate a corresponding low end acknowledgment.

To initiate the generation of the low end acknowledgment, the acknowledgment trigger 130 transmits a trigger signal TR1 over link 135 to the acknowledgment generator 140. The acknowledgment generator 140, in turn, generates the low end acknowledgment. The low end acknowledgment may be generated from an acknowledgment template stored in the acknowledgment generator 140 including protocol specific header data and an empty data payload. The acknowledgment generator 140 then forwards the low end acknowledgment to the low end network interface 110 over link 145 for transmission to source 152 over the low end network 150.

The trigger signal TR1 includes protocol-specific data from a header portion of a received high end acknowledgment, such as an acknowledgment type, an acknowledgment number, and source and destination addresses. For example, with respect to the TCP/IP protocol, the acknowledgment type indicates whether to acknowledge a request to establish a TCP session, the receipt of information data, or a request to close an established TCP session; the acknowledgment number corresponds to the next TCP sequence number that the high end destination 172 expects to receive; and the source and destination addresses each include an IP network address and a TCP port number. Other communication protocols may require a different set of protocol-specific header data for inclusion in the trigger signal.

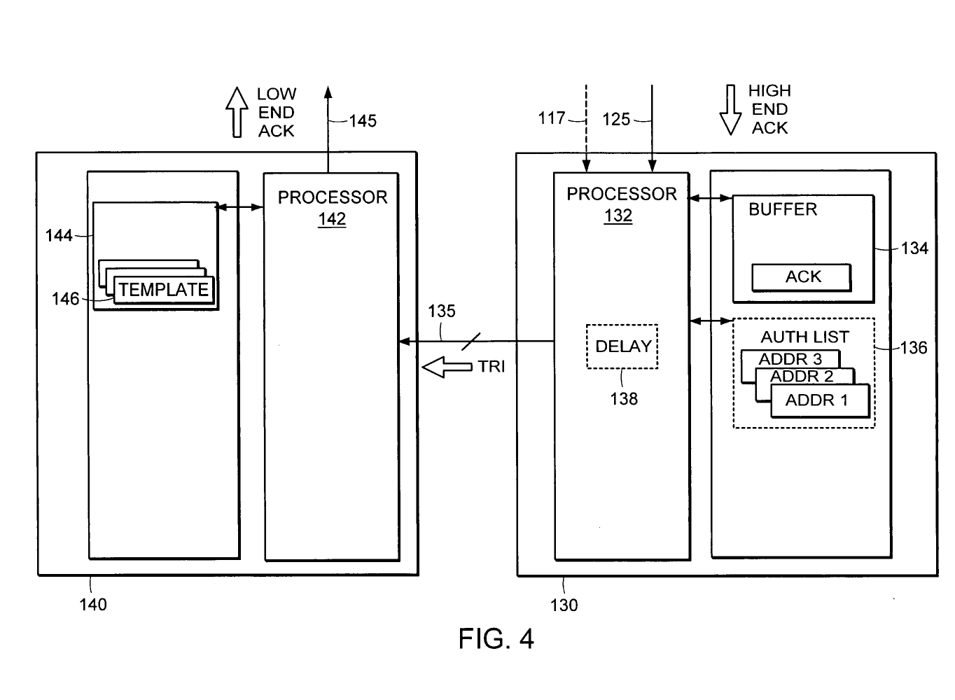

The acknowledgment trigger 130 and the acknowledgment generator 140 may be implemented as individual hardware components as described in FIG. 4. Alternatively, the acknowledgment trigger 130 and generator 140 may be implemented in software as in network isolator 100-3 of FIG. 1B. For example, the acknowledgment trigger 130 and generator 140 may be implemented as individual software objects implementing the steps of FIG. 2. The trigger signal may be generated by semaphores or function calls. For example, the acknowledgment generator 140 may generate a low end acknowledgment in response to the acknowledgment trigger 130 signaling a semaphore variable. Alternatively, the acknowledgment generator 140 may generate a low end acknowledgment in response to the acknowledgment trigger 130 calling a function defined in the generator 140 to initiate the process. Such functions may define calling parameters for passing header data from the received high end acknowledgment.

FIG. 4 is a diagram illustrating an acknowledgment trigger and an acknowledgment generator according to one embodiment. The acknowledgment trigger 130 includes a processor 132 and an input buffer 134. High end acknowledgments received over links 125, or at least data from the header portion, are written into buffer 134. According to one embodiment, the processor 132 generates the trigger signal TR1 by reading and extracting the protocol-specific header data from buffer 134. The processor 132, in turn, generates a trigger signal TR1 including the header data and transmits the signal to the acknowledgment generator 140 to initiate generation of the low end acknowledgment.

The acknowledgment generator 140 includes a processor 142 and template storage 144 for storing one or more acknowledgment templates 146 to generate the corresponding low end acknowledgments. Template storage 144 may include read only memory (ROM). An acknowledgment template 146 may be stored as a data structure that defines the default and open parameters of a low end acknowledgment according to a communication protocol. In response to the trigger signal TR1, processor 142 generates a low end acknowledgment by reading the acknowledgment template 146 from template storage 144 and then populating the open parameters of the template 146 with the header data from trigger signal TR1 (e.g., acknowledgment type, acknowledgment number, and source and destination addresses). The resulting low end acknowledgment is then forwarded to the low end network interface 110 over link 145 for transmission to the low end source 152.

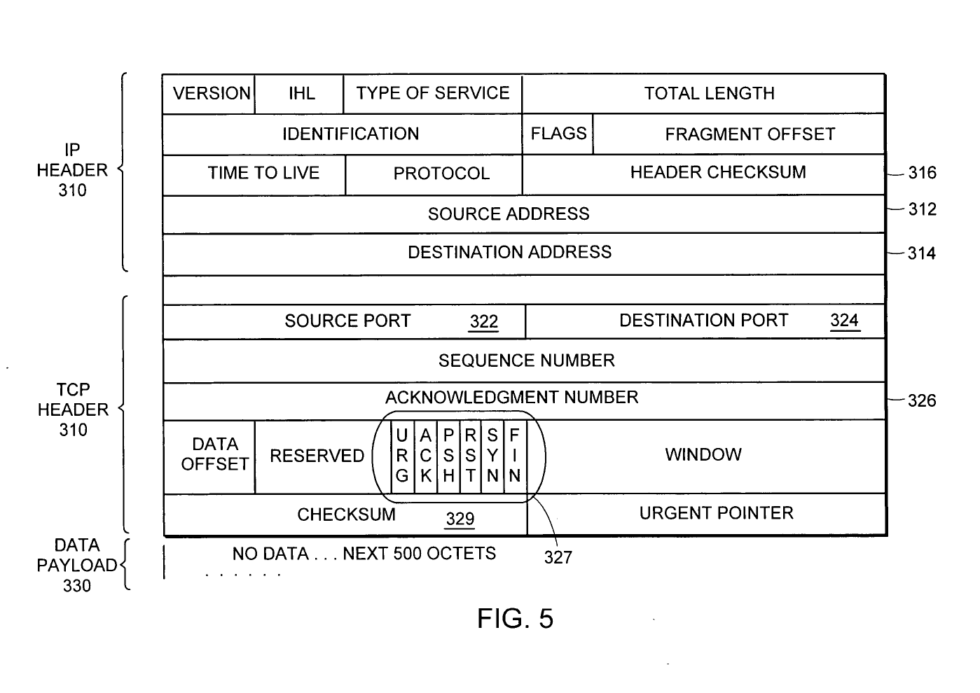

FIG. 5 is a diagram illustrating the open and default parameters of an acknowledgment template for TCP/IP according to one embodiment. In particular, the template defines open and default parameters for IP header 310, TCP header 320, and data payload 330. For example, in IP header 310, the open parameters maybe source address 312, destination address 314, and checksum 316. In TCP header 320, the open parameters may be source port 322, destination port 324, acknowledgment number 326, and checksum 329. TCP flags 327 may be either default or open parameters. The data payload 330 is preferably defaulted to zero or null. Checksums 316 and 329 are preferably recalculated by acknowledgment generator 140.

Referring back to FIG. 4, the acknowledgment trigger 130 may further process each of the high end acknowledgments individually to determine whether to generate the trigger signal at all. There are a number of different criteria that may be applied. For example, to prevent a malicious process on a high end destination 172 from transmitting sensitive information data to a low end source 152, processor 132 may scan the high end acknowledgment in buffer 134 for the existence of information data, such as in the data payload 330 of a TCP/IP packet. If information data exists, the high end destination 172 may be attempting to transfer information data to low end source 152 using the high end acknowledgment as a transfer mechanism. Thus, processor 132 preferably discards (e.g., deletes) the high end acknowledgment and does not generate a trigger signal.

To prevent transmissions of acknowledgments to unknown sources in the low end network 150, the acknowledgment trigger 130 may also include an authorization list 136 for identifying addresses of low end sources 152 that are authorized to receive low end acknowledgments. Thus, low end sources 152 that are identified in the authorization list 136 are allowed to receive low end acknowledgments, while high end acknowledgments to low end sources that are not included in the list are discarded. The authorization list 136 may be implemented as a table, linked list, or other known data structure.

The authorization list 136 maybe a static address list of known low end sources 152. Alternatively, the authorization list 136 may be a dynamic address list of low end sources 152 that have sent information data to one or more high end destinations 172 and are awaiting acknowledgment. The dynamic address list may be generated and maintained by tapping the data stream on link 115 and extracting the source addresses from the packets or frames in the stream. Referring to FIGS. 3 and 4, for example, link 117 taps the data stream on link 115 to processor 132, which extracts and writes the source addresses to the authorization list 136.

Furthermore, to prevent covert transmissions of information encoded in timed transmissions of acknowledgments, the acknowledgment trigger 130 may further include a delay 138. The delay 138 is preferably implemented as a random delay, which prevents a low end acknowledgment from being generated and transmitted from the network isolator within a known interval. By incorporating a random delay when triggering the acknowledgment generator 140, the network isolator 100 is effectively able to frustrate such covert data transfers by disrupting the timing mechanism of the covert data transfer protocol.

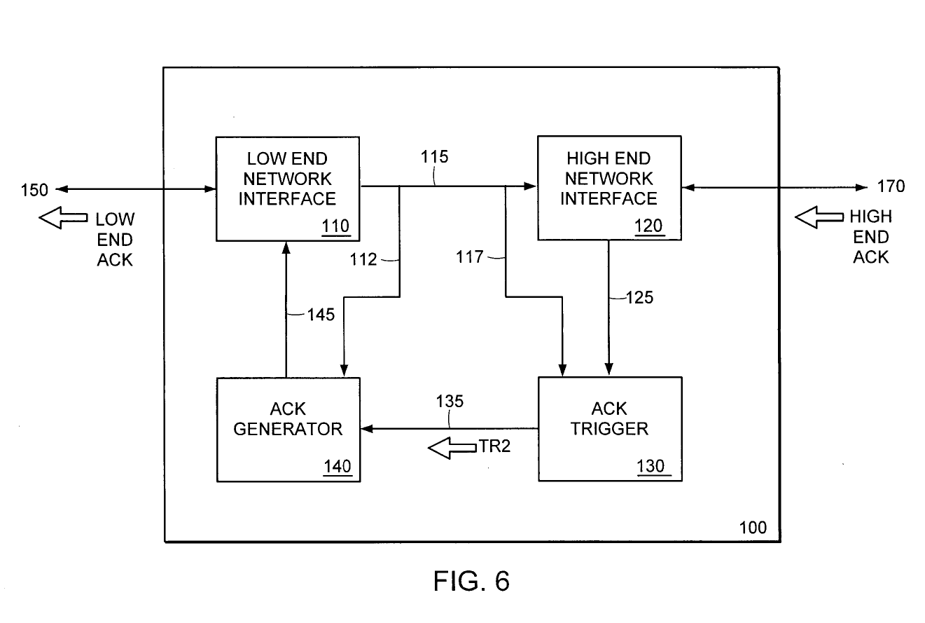

FIG. 6 is a diagram illustrating a network isolator according to an alternative embodiment. In the illustrated embodiment, the network isolator 100 implements the trigger signal as a binary enable signal. As such, trigger signal TR2 does not include header data for generating the corresponding low end acknowledgments. Rather, the acknowledgment generator 140 tracks the header data for a sequence of individual packets or frames by tapping the data stream on link 115 using tap link 112. In response to receiving trigger signal TR2, the acknowledgment generator 140 generates a low end acknowledgment from an acknowledgment template and populates the open parameters of the low end acknowledgment from the header data of the next unacknowledged packet or frame in the tracked sequence.

It is not unusual to receive packets out of sequence, particularly in TCP/IP environments. Thus, in this embodiment, the acknowledgment trigger 130 generates a binary trigger signal when the received high end acknowledgment corresponds to the next unacknowledged information data packet or frame in the sequence. Otherwise, no binary trigger signal is generated. In this way, when high end acknowledgments are received out of sequence, the acknowledgment trigger 130 prevents low end acknowledgments from being generated that acknowledge receipt of wrong information data.

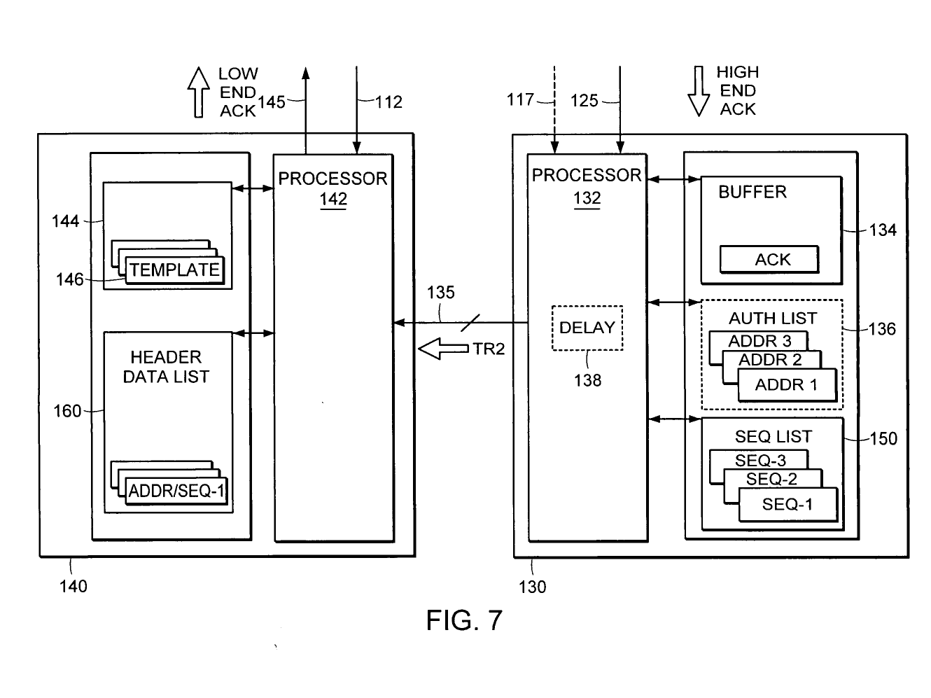

The acknowledgment trigger 130 and the acknowledgment generator 140 may be implemented as individual hardware components as described in FIG. 7. Alternatively, as discussed in FIG. 3, the acknowledgment trigger 130 and generator 140 may be implemented in software and providing the functionality as discussed in FIG. 7.

FIG. 7 is a diagram illustrating an acknowledgment trigger and an acknowledgment generator according to the embodiment of FIG. 6. The acknowledgment trigger includes processor 132, input buffer 134, and a sequence list 150. The sequence list 150 tracks the sequence numbers SEQ-1, SEQ-2, . . . of packets or frames traversing link 115. In particular, processor 132 extracts the sequence number from each packet or frame in the data stream via tap link 117 and writes the extracted sequence numbers to the sequence list 150 in the order traversed on link 115. For example, with TCP/IP, the sequence list 150 may include TCP sequence numbers 1000, 1003, and 1006.

For asynchronous networks, the sequence list 150 is preferably limited to tracking the sequence of packets or frames of a single active session, such as a TCP session, between a low end source 152 and a high end destination 172. This restriction may be imposed by the low end network interface 110 denying establishment of further communication sessions until a currently active session ends.

In response to receiving a high end acknowledgment, processor 132 references the first sequence number (e.g., SEQ-1) from sequence list 150 to determine whether to generate a binary trigger signal TR2. The first sequence number SEQ-1 corresponds to the next unacknowledged packet or frame in the tracked sequence. If the received high end acknowledgment corresponds to the referenced sequence number in the sequence list 150, acknowledgment trigger 130 generates a binary trigger signal TR2. Otherwise, no trigger signal is generated. For example, with TCP/IP, if the next referenced TCP sequence number in the list has a value of 1000, the corresponding high end acknowledgment has a TCP acknowledgment number of 1001.

In particular embodiments, when the received high end acknowledgment does not correspond to the referenced sequence number, the high end acknowledgment or portions of its header data (e.g., acknowledgment number) may be temporarily stored in buffer 134. If the buffered high end acknowledgment corresponds to a subsequently referenced sequence number (e.g., SEQ-2) in sequence list 150, the acknowledgment trigger 130 may then generate the trigger signal TR2, preferably before any protocol-specific packet timeout occurs. For example, with TCP/IP, if a TCP acknowledgment number having a value of 1101 is buffered, a binary trigger signal may be generated when a subsequently referenced TCP sequence number has a value of 1100.

The acknowledgment generator 140 includes processor 142, template storage 144, and header data list 160. The header data list 160 tracks the data from the header portions of a sequence of individual packets or frames traversing link 115. To generate the header data list 160, processor 142 taps into the data stream on link 115 through link 112 and extracts header data from each packet or frame in the stream. The extracted header data is then written into the header data list 160 in the order traversed over link 115. The extracted header data may include sequence numbers SEQ-1 and source and destination addresses ADDR of an active session. For example, with TCP/IP, each entry in the header data list 160 may store a TCP sequence number and an IP address and TCP port for the source and destination. Preferably, the order of the entries in the header data list 160 corresponds directly to the order of the entries in sequence list 150 of the acknowledgment trigger 130.

When processor 142 receives the binary trigger signal TR2, it generates a low end acknowledgment from an acknowledgment template 146 in template storage 144. Processor 142 then selects header data from the header data list 160 in a first-in, first-out manner, such that the selected header data corresponds to the next unacknowledged packet or frame in the tracked sequence. The selected header data is then used by processor 142 to populate the open parameters of the low end acknowledgment. For example, with TCP/IP, the acknowledgment number of the low end acknowledgment is populated with the TCP sequence number of the selected header data incremented by one. The source and destination addresses from the selected header data are injected into the open address parameters of the low end acknowledgment such that the source address is the destination address and vice versa.

After generating the low end acknowledgment, it is forwarded over link 145 to low end network interface 110 for transmission to the low end source 152.

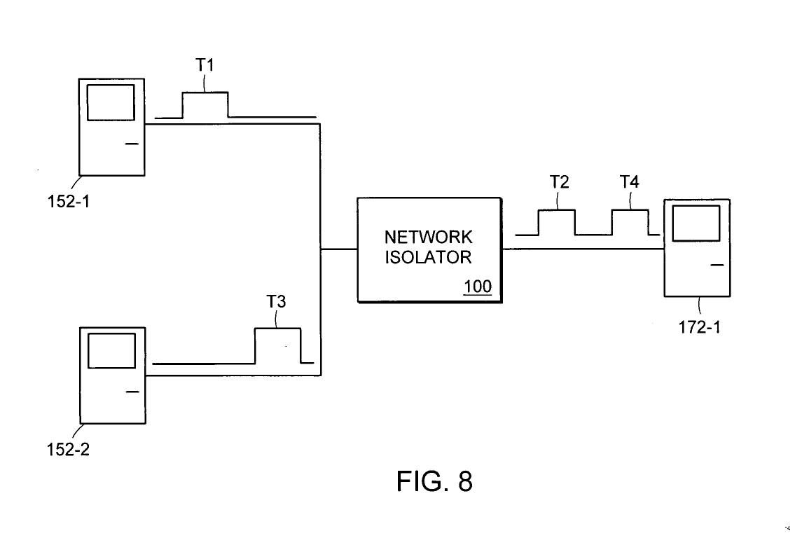

FIG. 8 is a diagram illustrating a network isolator in a time controlled network system according to one embodiment. In this embodiment, the network isolator 100 supports multiple active sessions between the low end sources and the high end destination while implementing binary trigger signals. In particular embodiments, the time controlled network is configured such that low end sources 152-1 and 152-2 transmit information data to high end destination 172-1 during time intervals T1 and T3 respectively. Conversely, high end destination 172-1 transmits acknowledgments to low end sources 152-1 and 152-2 during time intervals T2 and T4 respectively.

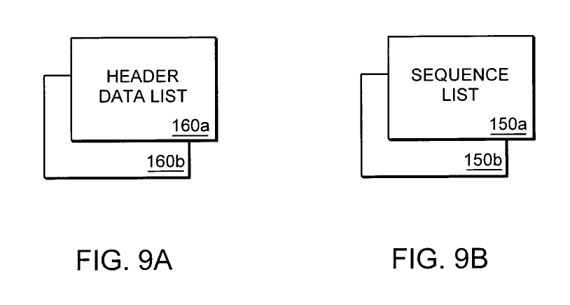

Embodiments of the network isolator 100 include modified structure of FIGS. 6 and 7 to support multiple active sessions. In particular, the acknowledgment generator 130 is modified to support multiple header data lists, such as header data lists 160a, 160b of FIG. 9A. Header data list 160a may track the header data for a sequence of packets or frames from low end source 152-1 to high end destination 172-1 during time interval T1. Similarly, header data list 160b may track the header data of the data stream from low end source 152-2 to high end destination 172-1 during time interval T3. In particular, processor 142 writes header data into one of the header data lists depending on the time interval in which the packet or frame is received. In this way, the header data for multiple sessions may be individually tracked.

When a binary trigger signal is received by processor 142 of acknowledgment generator 130 during time interval T2, the processor 142 is configured to reference header data list 160a to generate a low end acknowledgment for low end source 152-1 as described with respect to FIG. 7. Likewise, when the binary trigger signal is received during time interval T4, the processor 142 is configured to reference header data list 160b to generate a low end acknowledgment for low end source 152-2. In particular, processor 142 switches among multiple header data lists depending on the time interval in which the binary trigger signal is received in order to populate the low end acknowledgment from the corresponding header data.

The acknowledgment trigger 130 is also modified to support multiple sequence lists, such as sequence lists 150a, 150b of FIG. 9B. Sequence list 150a may track the sequence numbers of the packets or frames from low end source 152-1 to high end destination 172-1 during time interval T1. Similarly, sequence list 150b may track the sequence numbers of the packets or frames from low end source 152-2 to high end destination 172-1 during time interval T3. In particular, processor 132 writes sequence data into one of the sequence lists depending on the time interval in which the packet or frame is received.

When a high end acknowledgment is received during interval T2, it is known that the acknowledgment is intended for low end source 152-1 and processor 132 is configured to reference sequence list 150a to determine whether to generate a binary trigger signal as described in FIG. 7. Likewise, during time interval T4, sequence list 150b is referenced in response to receipt of a high end acknowledgment. The appropriate sequence list 150a or 150b may also be determined by reading the destination address of the received acknowledgment and referencing the corresponding list.

Many other features may be implemented in such a device. For example, a logger may be implemented within the acknowledgment trigger utilizing local memory or external memory in the high end network to maintain records of the acknowledgment triggering and, thus, permit security auditing. Alternatively, a computing device on the high end network may monitor networking functions using check sums and a one way hash to avoid manipulation of the network stack. None, all or any combination of these enhancements as well as others known to those skilled in the art may be used in building such systems.

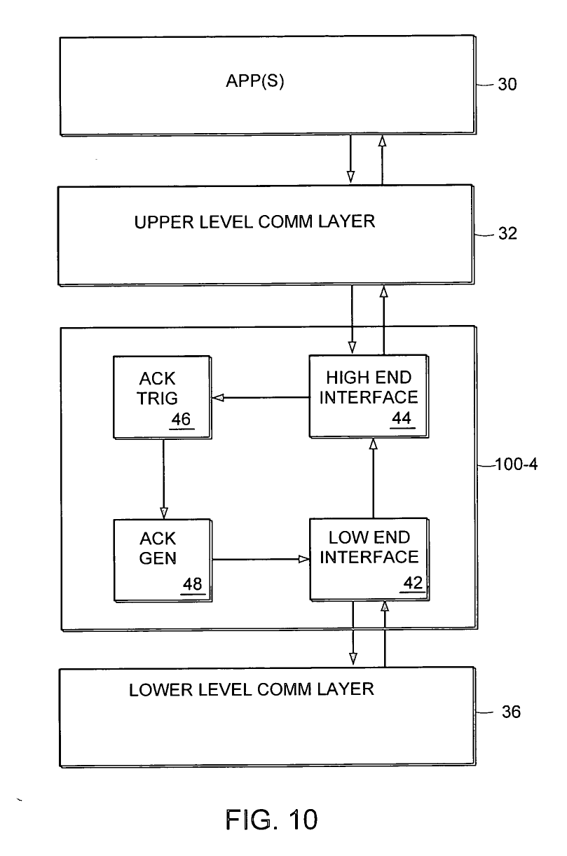

FIG. 10 is a diagram illustrating details of the network isolator according to the embodiment of FIG. 1C. In this embodiment, the network isolator 100-4 is an embedded software component for providing secured access to the software application processes 30. In particular, the network isolator 100-4 may be embedded between an upper level communication layer 32 and a lower level communication layer 36.

For example, in the context of a layered communications model, such as the Open System Interconnection (OSI) model, the upper level communication layer 32 may include software components for implementing one or more layers corresponding to the Presentation, Session, and Transport layers, while the lower level communication layer 36 may include software and/or hardware components for implementing one or more layers corresponding to the Network, Datalink, and Physical layers.

As one example, the network isolator may be embedded between a transport layer protocol (e.g., TCP) in the upper layer 32 and a network layer protocol (e.g., IP) in the lower layer 36. In another example, the network isolator may be embedded between a network layer protocol (e.g., IP) in the upper layer 32 and a datalink layer protocol (e.g., Ethernet datalink) in the lower layer 36. Other implementations for embedding a network isolator 100-4 between upper and lower level communication layers are possible, including those of models different from the OSI model.

In the illustrated embodiment, the network isolator 100-4 includes a low end software communication interface 42, a high end software communication interface 44, an acknowledgment trigger 46, and an acknowledgment generator 48. The low end and high end communication interfaces 42, 44 communicate with each other to pass information data received at the lower level communication layer 36 up to the high level communication layer 32 for forwarding to a destination software process 30. The high level communication layer 32 sends an acknowledgment from or on behalf of the destination process 30 to the high end interface 44, which then passes the high end acknowledgment to the acknowledgment trigger 46.

Trigger 46 determines whether to generate and transmit an acknowledgment to the low end source, and if so, generates a trigger signal, for example, by signaling a semaphore or by calling a function defined in the acknowledgment generator 48. Such function calls may include calling parameters for passing header data from the high end acknowledgment.

In response to the trigger signal, the acknowledgment generator 48 generates the low end acknowledgment from, for example, a software template or as a new instance of a class of object that generates acknowledgments from a template restricting the values placed in the acknowledging packet or frame. After generating the low end acknowledgment, generator 48 passes the acknowledgment to the low end interface 42, which then forwards the acknowledgment to the low level communication layer 36 for transmission to the originating source.

In an alternative embodiment, the use of high end and low end communication interfaces may be avoided, such that the low level communication layer 36 forwards packets or frames directly to the high level communication layer 32. In the reverse direction, the acknowledgment trigger 46 intercepts packets from the high level communication layer 32 and processes them as previously described. After generating the acknowledgments, the acknowledgment generator 48 communicates directly with the low level communication layer 36, such that the low end acknowledgments are sent to the low level communication layer 36 for transmission.

While this invention has been particularly shown and described with references to preferred embodiments thereof, it will be understood by those skilled in the art that various changes in form and details may be made therein without departing from the scope of the invention encompassed by the appended claims.

1. A method of communicating data from a low security assurance source to a high security assurance destination comprising:
receiving data from a low security assurance source according to a communication protocol and transferring the data to a high security assurance destination according to the communication protocol;
receiving a high end acknowledgment according to the communication protocol from the high security assurance destination;
generating an acknowledgment trigger signal in response to the high end acknowledgment; and
generating a low end acknowledgment according to the communication protocol in response to the acknowledgment trigger signal.

2. The method of claim 1 further comprising:
determining whether to generate an acknowledgment trigger signal.

3. The method of claim 2 wherein determining whether to generate the acknowledgment trigger signal comprises:
determining whether the high end acknowledgment includes information data; and
generating no acknowledgment trigger signal if information data is included in the high end acknowledgment.

4. The method of claim 2 wherein determining whether to generate the acknowledgment trigger signal comprises:
determining whether the low security assurance source is authorized to receive acknowledgments; and
generating no acknowledgment trigger signal if the low security assurance source is not authorized.

5. The method of claim 1 further comprising:
delaying the acknowledgment trigger signal in order to delay generation of the low end acknowledgment.

6. The method of claim 1 wherein the acknowledgment trigger signal includes header data for generating the low end acknowledgment.

7. The method of claim 6 further comprising:
generating the low end acknowledgment from an acknowledgment template; and
populating the low end acknowledgment with the header data from the acknowledgment trigger signal.

8. The method of claim 1 wherein the acknowledgment trigger signal is an binary enable signal.

9. The method of claim 8 further comprising:
tracking a sequence of plural data transmission units transferred to the high security assurance destination; and
generating the acknowledgment trigger signal if the received high end acknowledgment corresponds to a next unacknowledged data transmission unit in the tracked sequence.

10. The method of claim 8 further comprising:
tracking multiple sequences of plural data transmission units transferred to the high security assurance destination;
referencing one of the tracked sequences that corresponds to a time interval in which the high end acknowledgment is received; and
generating the acknowledgment trigger signal if the received high end acknowledgment corresponds to a next unacknowledged data transmission unit in the referenced sequence.

11. The method of claim 8 further comprising:
tracking header data for each data transmission unit in a sequence of plural data transmission units transferred to the high security assurance destination;
generating the low end acknowledgment from an acknowledgment template in response to the acknowledgment trigger signal; and
populating the low end acknowledgment with the header data for a next unacknowledged data transmission unit in the sequence.

12. The method of claim 8 further comprising:
tracking header data for multiple sequences of plural data transmission units transferred to the high security assurance destination;
generating the low end acknowledgment from an acknowledgment template in response to the acknowledgment trigger signal;
referencing the header data of one of the tracked sequences that corresponds to a time interval in which the acknowledgment trigger signal is received; and
populating the low end acknowledgment with the header data for a next unacknowledged data transmission unit in the referenced sequence.

13. A system for communicating data from a low security assurance source to a high security assurance destination comprising:
a first communication interface receiving data from a low security assurance source according to a communication protocol and transferring the data to a high security assurance destination according to the communication protocol;
a second communication interface receiving a high end acknowledgment according to the communication protocol from the high security assurance destination;
an acknowledgment trigger generating an acknowledgment trigger signal in response to the high end acknowledgment; and
an acknowledgment generator generating a low end acknowledgment according to the communication protocol in response to the acknowledgment trigger signal.

14. The system of claim 13 wherein the acknowledgment trigger determines whether to generate an acknowledgment trigger signal.

15. The system of claim 14 wherein the acknowledgment trigger determines whether the high end acknowledgment includes information data and generates no acknowledgment trigger signal if information data is included in the high end acknowledgment.

16. The system of claim 14 wherein the acknowledgment trigger further comprises:
an authorization list identifying low security assurance sources that are authorized to receive low end acknowledgments;
the authorization list being referenced to determine whether an intended recipient of the high end acknowledgment is authorized to receive acknowledgments; and
the acknowledgment trigger generating no acknowledgment trigger signal if the low security assurance source is not identified in the authorization list.

17. The system of claim 13 wherein the acknowledgment trigger further comprises:
a delay that delays the acknowledgment trigger signal for a random time period in order to delay generation of the low end acknowledgment.

18. The system of claim 13 wherein the acknowledgment trigger signal includes header data for generating the low end acknowledgment.

19. The system of claim 18 wherein the acknowledgment generator generates the low end acknowledgment from an acknowledgment template and populates the low end acknowledgment with the header data from the acknowledgment trigger signal.

20. The system of claim 13 wherein the acknowledgment trigger signal is a binary enable signal.

21. The system of claim 20 wherein the acknowledgment trigger further comprises:
a sequence list that tracks a sequence of plural data transmission units transferred to the high security assurance destination;
the sequence list being referenced to determine whether the received high end acknowledgment corresponds to a next unacknowledged data transmission unit in the tracked sequence; and
the acknowledgment trigger generating the trigger signal if the received high end acknowledgment corresponds to the next unacknowledged data transmission unit in the referenced sequence list.

22. The system of claim 20 wherein the acknowledgment trigger further comprises:
plural sequence lists that tracks multiple sequences of plural data transmission units transferred to the high security assurance destination;
one of the plural sequence lists being referenced that corresponds to a time interval in which the high end acknowledgment is received; and
the acknowledgment trigger generating the acknowledgment trigger signal if the received high end acknowledgment corresponds to a next unacknowledged data transmission unit in the referenced sequence list.

23. The system of claim 20 wherein the acknowledgment generator further comprises:
a header data list that tracks header data for each data transmission unit in a sequence of plural data transmission units transferred to the high security assurance destination;
the acknowledgment generator generates the low end acknowledgment from an acknowledgment template in response to the acknowledgment trigger signal; and
the acknowledgment generator populates the low end acknowledgment with the header data from the header data list for a next unacknowledged data transmission unit in the sequence.

24. The system of claim 20 wherein the acknowledgment generator further comprises:
plural header data lists that tracks header data for multiple sequences of plural data transmission units transferred to the high security assurance destination;
the acknowledgment generator generates the low end acknowledgment from an acknowledgment template in response to the acknowledgment trigger signal;
one of the plural header data lists that corresponds to a time interval in which the acknowledgment trigger signal is received being referenced for header data of one of the tracked sequences; and
the acknowledgment generator populates the low end acknowledgment with the header data from the referenced header data list for a next unacknowledged data transmission unit in the sequence.

25. A system for communicating data from a low security assurance source to a high security assurance destination comprising:
means for receiving data from a low security assurance source according to a communication protocol and transferring the data to a high security assurance destination according to the communication protocol;
means for receiving a high end acknowledgment according to the communication protocol from the high security assurance destination;
means for generating an acknowledgment trigger signal in response to the high end acknowledgment; and
means for generating a low end acknowledgment according to the communication protocol in response to the acknowledgment trigger signal.

26. The method of claim 1 wherein the communication protocol is an acknowledgment based communication protocol.

27. The method of claim 1 wherein the acknowledgment based communication protocol is a handshaking protocol.

28. The method of claim 1 wherein the high security assurance destination is a software process.

29. The system of claim 13 wherein the first and second communication interfaces are network interfaces.

30. The system of claim 13 wherein the first and second communication interfaces are software communication interfaces.

31. The system of claim 13 wherein the high security assurance destination is a software process.

32. The system of claim 13 wherein the system is a network device.

33. The system of claim 13 wherein the system is an output port.

34. The system of claim 13 wherein the system is an embedded software component.
